(19) United States
(12) Patent Application Publication
(10) Pub. No.: US 2004/0076002 A1
(43) Pub. Date: Apr. 22, 2004

(54) Memory controller

(76) Inventor: Masakatsu Uneme, Kanagawa (JP)

Correspondence Address: Darryl G. Walker, WALKER & SAKO, LLP, Suite 235, 300 South First Street, San Jose, CA, 95113, US

(21) Appl. No.: 10/672,972

(22) Filed: Sep. 26, 2003

(30) Foreign Application Priority Data
Sep. 30, 2002 (JP) 2002-287331

(51) Int. Cl. F21V 23/02

(52) U.S. Cl. 362/222

(57) ABSTRACT

A memory controller can accurately synchronize a strobe signal generated from a clock signal with respect to digital data for inputting/outputting digital data to/from a semiconductor memory device, such as double-data-rate (DDR) synchronous dynamic random access memory (SDRAM), or the like. Output holding circuits (108) can be situated adjacent to corresponding data output terminal (105). One of (n/2) output delay circuits (112) can be situated adjacent to every two of n signal output terminals (112). Wiring lengths from output holding circuits (108) to data output terminals (105) can be made essentially equal to wiring lengths between the output of each delay circuit (112) and the corresponding signal output terminals (112). A delay of digital data transmitted from output holding circuits (108) to data output terminals (105) can be made essentially equal to a delay of an output strobe signal transmitted from output delay circuits (112) to corresponding signal output terminals (106).

### TECHNICAL FIELD

The present invention relates to generally to a memory controller for inputting/outputting digital data to/from a semiconductor memory device, and more particularly to a memory controller that inputs/outputs digital data synchronously with a strobe signal.

### BACKGROUND OF THE INVENTION

A typical data processing system can include a microprocessor (or some other computing device) and one or more semiconductor memory devices that can provide data to the microprocessor. In recent years, the data throughput of microprocessors has been enhanced. Thus, the operating speed of a semiconductor memory device can become a limit to the processing speed of the processing system. One approach to increasing the operating speed for a semiconductor memory device is the use of a double-data-rate (DDR) synchronous dynamic random access memory (SDRAM).

In DDR-SDRAM, digital data can be input to, or output from the DDR-SDRAM on both the rise and fall of a clock signal. In this way, operating speed for the DDR-SDRAM can be faster than other SDRAMs that input/output data on only one (e.g., rising) edge of a clock signal.

A transfer of data between a DDR-SDRAM and a microprocessor can be carried out by a memory controller. One example of a memory controller is set forth in Japanese Patent Publication 2001-331365 A.

In a write operation to a DDR-SDRAM, data can be written through a memory controller. A DDR-SDRAM can capture the write data, output synchronously with a clock signal from the memory controller, in response to an edge of a strobe signal provided by the memory controller.

Referring now to FIG. 12, a timing diagram is set forth showing a conventional write operation. As shown in FIG. 12, in order to ensure stable data (DATA) is written into a DDR-SDRAM, the memory controller delays a strobe signal STROBE with respect to a clock signal CLOCK.

In addition, in a read operation for a DDR-SDRAM, data is read out from the DDR-SDRAM by the memory controller. A DDR-SDRAM can output read data synchronously with a clock signal from the memory controller. Thus, as can also be shown in FIG. 12, in order to ensure stable data (DATA) is read from a DDR-SDRAM, the memory controller delays a strobe signal STROBE with respect to a clock signal CLOCK.

An internal configuration of a conventional memory controller will now be described with reference to block diagrams shown in FIGS. 10 and 11. For the sake of simplicity, the conventional memory controller will be described with reference to the writing of data to a DDR-SDRAM and the reading of data from the DDR-SDRAM.

Referring to FIGS. 10 and 11, in the following description, it will be assumed a memory controller 200 has a circuit core region 202 and an interface region 203 provided around the periphery of the circuit core region 202. A data storing circuit 211, a clock generating circuit 212, and an output delay circuit 213 can be formed within the circuit core region 202. Data input/output (I/O) terminals 215, signal I/O terminals 216, first stage flip-flops (FFs) 217, final stage FFs 218, input delay circuits 219, and data delay circuits 220 are formed in an interface region 203.

The constituent elements of conventional memory control circuit 200 will now be briefly described.

Data storing circuit 211, for example, is composed of a cache register to store digital data input/output through data terminals 215. Clock generating circuit 212 is composed of a phase locked loop (PLL) circuit to generate the output clock signal. The output delay circuit 213 can receive as an input the clock signal from clock generating circuit 212 and output a delayed clock signal, which is obtained by delaying the clock signal by a predetermined amount (e.g., a quarter cycle).

One signal I/O terminal 216 can be provided for each predetermined group of data I/O terminals (e.g., every 8 bits). When data is output from memory controller 200 to the DDR-SDRAM, a signal I/O terminal 216 can receive as an input the delayed clock signal. Similarly, when the memory controller 200 receives input data from the DDR-SDRAM, signal I/O terminal 216 can receive as its input a clock signal from the DDR-SDRAM.

First stage FFs 217 can receive as inputs data signals supplied to data I/O terminals 215 through delay circuits 220. First stage FFs 217 would then capture such data in response to strobe signals from input delay circuits 219. Final stage FFs 218 capture data from the data storing circuit 211 in response to a clock signal from clock signal generating circuit 212. Such captured data is then supplied to data I/O terminals 215 through signal lines 225.

The input delay circuit 219 delays the clock signal supplied from the DDR-SDRAM to the signal I/O terminals to generate the strobe signal. The data delay circuits 220 receive as data supplied from wirings 2211 as inputs. Such data is delayed a predetermined amount of time, and then supplied to first stage FFs 217.

Next, a description will be given with respect to a write operation to a DDR-SDRAM through memory controller 200 with respect to FIG. 10.

Referring to FIG. 10, memory controller 200 stores data in data storing circuit 211. Write data stored therein can be provided to final stage FFs 218. Such write data can be output to the DDR-SDRAM through wirings 225 and data I/O terminals 215. In the write operation, a clock signal can be input to clock terminals final stage FFs 218. Such a clock signal can be obtained by skew adjusting the clock signal generated by clock generating circuit 212 using clock tree synthesis (CTS). Thus, all final stage FFs 218 used to write data, hold such data at the same time for output to data I/O terminals 215.

In the above conventional example, it is assumed that the plurality of wirings 225 distributed between the final stage FFs 218 and data I/O terminals 215 can have the same length.

As noted above, memory controller 200 must output a strobe signal obtained by delaying a clock signal by a predetermined amount (i.e., a quarter signal). Thus, the memory controller 200 has an output delay circuit 213 for receiving a clock signal from the clock generating circuit 212 to generate a strobe signal obtained by delaying the clock signal. The strobe signal, in a similar fashion to the clock signal, is skew adjusted using CTS, and then supplied to the DDR-SDRAM through signal I/O terminals 216.

In this way, data and a strobe signal can be supplied from memory controller 200 to the DDR-SDRAM. The DDR-SDRAM can then capture the data in response to the strobe signal.

Next, a description will be given with respect to a read operation from a DDR-SDRAM to memory controller 200 with reference to FIG. 11.

The memory controller 200 receives data output from the DDR-SDRAM at data I/O terminals 215 and clock signals at signal I/O terminals 216. Data input at data I/O terminals 215 is supplied to data delay circuits 220 through wirings 2211. After being skew-adjusted, such data is supplied to first stage FFs 217 through wirings 2212. A clock signal is input to signal I/O terminal 216 and supplied to an input delay circuit 219 through wirings 222. Then, a strobe signal, obtained by delaying the clock signal with input delay circuit 219, is supplied to clock terminals of first stage FFs 217. The delay amount can be one quarter of a clock cycle, for example. First stage FFs 217 latch data supplied through data delay circuits 220 in response to an active strobe signal.

In the conventional arrangement of FIG. 11, the data delay circuits 220 are provided to adjust for any timing divergence between data values due to different differences from an output terminal OUT of input delay circuit 219 to clock terminals of first stage FFs 217. Also, each data delay circuit 220 can carry out skew-adjustment according to predetermined delay quantities for corresponding first stage FFs 217.

In this way, data and a clock signals are supplied from the DDR-SDRAM to the memory controller 200, and the memory controller 200 captures the data from data delay circuits 220 in response to a strobe signal obtained by delaying the clock signal.

It is noted that in the conventional memory controller of FIG. 10, the clock generating circuit 212, for generating the clock signal used to synchronize data, and the output delay circuit 213, for generating the strobe signal, are both provided in the circuit core region 202. Also, the clock signal is supplied to the final stage FFs 218 and the strobe signal is provided to the signal I/O terminals 216 using CTS in the interface region.

In the conventional memory controller 200, because the signal generation source for the clock signal is different from that of the strobe signal, separate CTS steps are applied for the two different signals. As a result, the skew between a clock signal and a strobe signal needs to be specially adjusted. Thus, due to such separate CTS steps, a problem arises in that the skew between such signals can be worse, as compared to one independent CTS approach.

In addition, the application of CTS to a multiple signals (e.g., clock and strobe), results in a number of clock trees being placed in the interface region 203. As a result, chip size can increase, and the degree in freedom of design can be reduced.

Moreover, in the conventional memory controller of FIG. 11, wiring lengths from the output terminal of the input delay circuit 219 to the various clock terminals of the first stage FFs 217 are different from one another. As a result, chip area must be provided for data delay circuits 220 for each first stage FF 217, increasing overall chip size. Further, particular delay amounts must be set for each data delay circuit 220. This can require considerable man-hours to accomplish. For this reason, a conventional memory controller like that of FIG. 11 can have increased chip area, and increased production time.

In light of the above, it would be desirable to arrive at a memory controller that is capable of accurately writing data to, and reading data from, a memory device (e.g., a DDR-SDRAM) that does not require as much chip area and/or chip production time, as conventional memory controllers.

### SUMMARY OF THE INVENTION

According to the present invention, a memory controller can include a clock generating circuit that generates an output clock signal, a data generating circuit that provides output digital data, “m data output terminals that provide output data to the semiconductor memory device in parallel, m output holding circuits for storing the output digital data synchronously with the output clock signal, and n signal output terminals that provide output strobe signals to the semiconductor memory device in synchronism with the output data. A number n can be less than m. In addition, the memory controller can include an output delay circuit for every “p” signal output terminal(s). Each output delay circuit can delay the output clock signal by a predetermined amount to transmit an output strobe signal to corresponding p signal output terminal(s). The value p can be an integer greater than zero. Each m output holding circuit can be physically adjacent to a corresponding one of the m data output terminals. Further, the output of each output delay circuit can be adjacent to the corresponding p signal output terminal(s).

According to one aspect of the embodiments, the m output data output terminals and n signal output terminals can be linearly aligned with one another. The m holding circuits can also be linearly aligned with one another. In addition, the plurality of output delay circuits can be linearly aligned with one another between the holding circuits and the data and signal output terminals.

According to another aspect of the embodiments, a value p can be greater than one, and the value n can be a multiple of p.

According to another aspect of the embodiments, a value p can be selected from the group consisting of one and two.

According to another aspect of the embodiments, the value of p is one.

According to another aspect of the embodiments, the value of p is two, and each output delay circuit can have an output terminal arranged equidistant from the corresponding two signal output terminals.

According to another aspect of the embodiments, a memory controller can further include a plurality of data input terminals that receive input data from the semiconductor memory device, a signal input terminal for every “q” data input terminals. Each signal input terminal receiving a device input clock signal from the semiconductor memory device in synchronism with the input data. In addition, an input delay circuit can be included corresponding to each signal input terminal that delays a received device input clock from the semiconductor memory device signal by a predetermined amount to generate an input strobe signal. The input delay circuits can be arranged between the signal input terminals and positions where the input delay circuits output the input strobe signals. Still further, an input holding circuit can be provided corresponding to each data input terminal, each group of q input holding circuits holding input data in synchronism with the input strobe signal from a corresponding input delay circuit. The input data can be transmitted to the data generating circuit through the data input terminals.

According to another aspect of the embodiments, a memory controller can include a first wiring corresponding to each data input terminal that transmits digital data to a corresponding input holding circuit and a second wiring corresponding to each input holding circuit that transmits the input strobe signal from a corresponding input delay circuit to the input holding circuit. The first and second wiring corresponding to each input holding circuit can be essentially equal in length.

According to another aspect of the embodiments, m data output terminals can also be data input terminals that receive input data from the semiconductor memory device in parallel. Further, n signal output terminals are also signal input terminals for receiving device input clock signals from the semiconductor memory device in synchronism with the input data.

According to another aspect of the embodiments, the output holding circuits can transmit output digital data synchronously with both a rising edge and a falling edge of the output clock signal.

According to another aspect of the embodiments, input holding circuits can transmit input data to the data generating circuit synchronously with both a rising edge and a falling edge of the corresponding input strobe signal.

According to another aspect of the embodiments, the semiconductor memory device can be coupled to the memory controller by the m data output terminals and the n signal output terminals.

According to another aspect of the embodiments, the memory controller can include a circuit core region and an interface region surrounding the circuit core region. The clock generating circuit and data generating circuit can be formed in the circuit core region. The data output terminals, output holding circuits, signal output terminals, and output delay circuits can be formed in the interface region. Each output holding circuit can comprise a first latch circuit.

According to another aspect of the embodiments, a memory controller can further include data output terminals being data input/output (I/O) terminals, the signal output terminals being signal I/O terminals. Further, m input holding circuits corresponding to the data I/O terminals can be formed in an interface region. Each input holding circuit can comprise a second latch circuit connected to a corresponding data I/O terminal by a first wiring. The input holding circuits can hold input data in synchronism with a corresponding input strobe signal. The memory controller can also include an input delay circuit connected to each signal I/O terminal by a second wiring. Each input delay circuit can delay a device input clock from the semiconductor memory device signal by a predetermined amount to generate an input strobe signal. Each input strobe signal can be connected to a corresponding second latch circuit by a third wiring. The length of the first wiring to each second latch circuit can be essentially equal to the sum of the lengths of the second and third wirings corresponding to the same second latch circuit.

The present invention may also include memory controller having m data input terminals that receive input data from the semiconductor memory device, n signal input terminals, each receiving a device input clock signal from the semiconductor memory device in synchronism with the input data. The value m can be greater than n. Further included are a data storing circuit for receiving digital data from the data input terminals, n input delay circuits that delay received device input clocks from the semiconductor memory device signal by a predetermined amount to generate input strobe signals, m input holding circuits that hold the input data in synchronism with the input strobe signals form the input delay circuits. Still further, m data input wirings can be provided, each data input wiring transmitting an input data value from one data input terminal to a corresponding input holding circuit. Also, m signal input wirings can be provided that transmit one input strobe signal from one input delay circuit to a corresponding input holding circuit. The data input wiring and signal input wiring for the same corresponding input holding circuit can be essentially equal in length.

According to one aspect of the embodiments, input delay circuits can be arranged between the signal input terminals and locations where the input delay circuits output the input strobe signals.

According to another aspect of the embodiments, the memory controller can include a circuit core region and an interface region surrounding the circuit core region. The data storing circuit can be formed in the circuit core region. The data input terminals, input holding circuits, signal input terminals, input delay circuits, signal input wirings, and data input wirings can be formed in the interface region. Each input holding circuit can comprise a first latch circuit.

According to another aspect of the embodiments, the data input terminals and signal input terminals are linearly aligned with one another, and the input holding circuits are linearly aligned with one another parallel to the data input terminals and signal input terminals.

It is understood that the various constituents of the invention described above are not necessarily independent from one another. Various constituents can form a single member. Further, one part of one constituent can be part of one member, while another is part of another member. Still further, parts of one constituent element can overlap those of another constituent element.

In addition, the present invention describes various “clock” signals. It is understood that such signals can be input or output in synchronism with digital data. Hence such a signal can be different from a system clock signal, or the like.

### BRIEF DESCRIPTION OF THE DRAWINGS

FIG. 1 is a schematic plan view showing a portion of a memory controller according to one embodiment of the present invention.

FIG. 2 a schematic plan view showing another portion of a memory controller according to an embodiment of the present invention.

FIG. 3 a schematic plan view of a memory controller according to an embodiment of the present invention.

FIG. 4 is a top plan view showing a circuit layer for a portion of a memory controller according to one embodiment of the present invention.

FIG. 5 is a schematic plan view showing a portion of a memory controller according to one possible modification of an embodiment of the present invention.

FIG. 6 is a schematic plan view showing a portion of a memory controller according to another possible modification of an embodiment of the present invention.

FIG. 7 is a schematic plan view showing a portion of a memory controller according to another possible modification of an embodiment of the present invention.

FIG. 8 is a schematic plan view showing a portion of a memory controller according to another possible modification of an embodiment of the present invention.

FIG. 9 is a schematic plan view showing a portion of a memory controller according to yet another possible modification of an embodiment of the present invention.

FIG. 10 is a top plan view of a conventional memory controller.

FIG. 11 is a schematic plan view showing a portion of a conventional memory controller.

FIG. 12 is a timing diagram showing various signals of a memory controller.

### DETAILED DESCRIPTION OF THE EMBODIMENTS

Various embodiments of the present invention will now be described in detail with reference to accompanying drawings. In the embodiments shown, a data processor (not shown) can include a semiconductor memory device, such as a double-data-rate (DDR) synchronous dynamic random access memory (SDRAM), and a memory controller. The DDR-SDRAM and memory controller can be connected to one another.

It is understood that while the various embodiments refer to a DDR-SDRAM as a memory device, the present invention should not be limited to such a particular type of memory device.

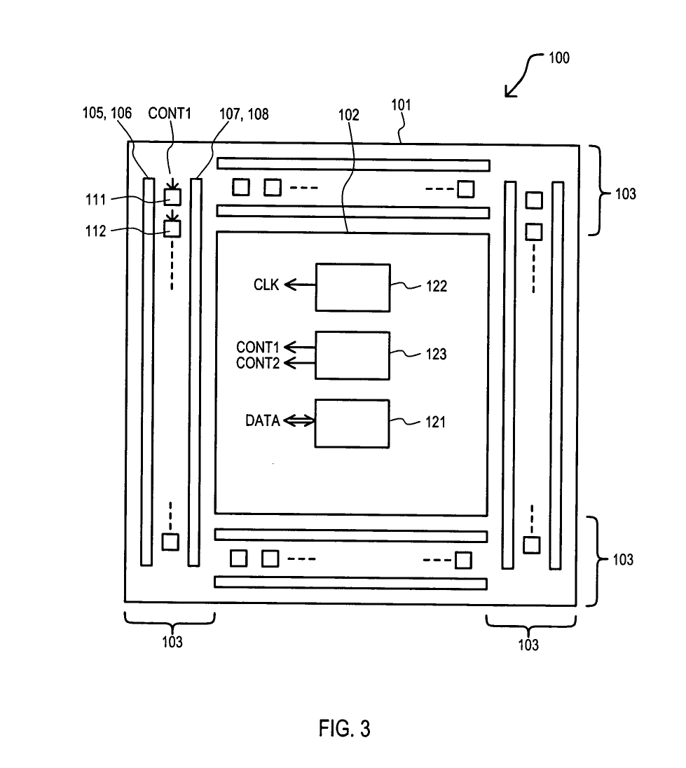

Referring now to FIG. 3, a memory controller according to one embodiment is set forth in schematic plan view and designated by the general reference character 100. A memory controller 100 can include a circuit core 102 formed in the center of a circuit substrate 101, and an interface portion 103 formed in the peripheral region of the circuit substrate 101 that does not include the circuit core 102. A circuit substrate 101 can have a generally rectangular shape, as but one example.

A circuit core 102 can include an internal logic region. A data storing circuit 121, a clock generating circuit 122, a delay adjusting circuit 123, and the like, can be formed in the internal logic region. A data storing circuit 121 of circuit core 102 can be composed of a cache register, as but one example. Digital data values can be stored within the data storing circuit 121. Such digital data values may be continuously updated as data is transferred between a memory device and a data processor. A clock generating circuit 122 can be composed of a phase-locked-loop (PLL) circuit, for example.

Interface region 103 can include various kinds of circuits for mediating communication between the circuit core 102 and a DDR-SDRAM. Arranged within the interface region 103 can be data input/output (I/O) terminals 105, signal I/O terminals 106, first stage flip-flops (FFs) 107, final stage FFs (108), input delay circuits 111, and output delay circuits 112.

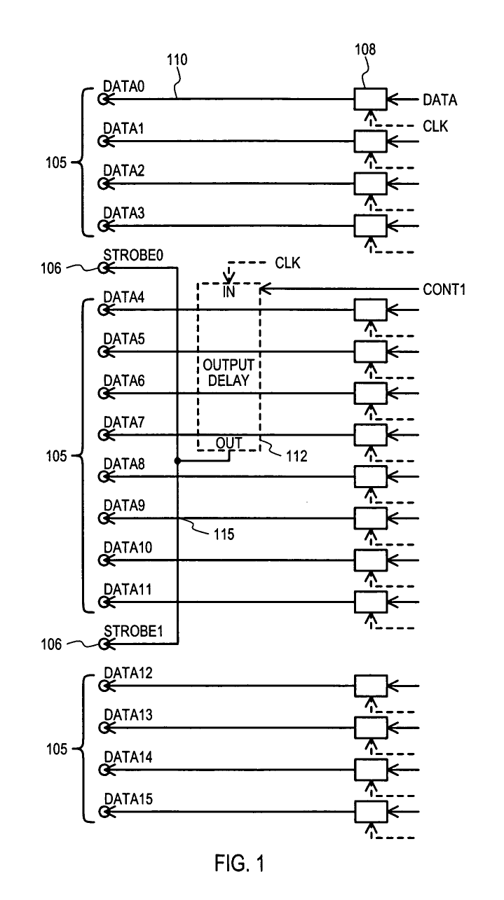

A memory controller according to an embodiment will be described more specifically now with reference to FIGS. 1 to 3.

Referring now to FIGS. 1 to 3, a memory controller can include “m” data I/O terminals 105 that can serve as both data input terminals and data output terminals. Also included are “n” signal I/O terminals 106 serving as both signal input terminals and signal output terminals. As shown in FIG. 3, data I/O terminals 105 and signal I/O terminals 106 can be arranged in a line in the vicinity of the four sides of circuit substrate 101.

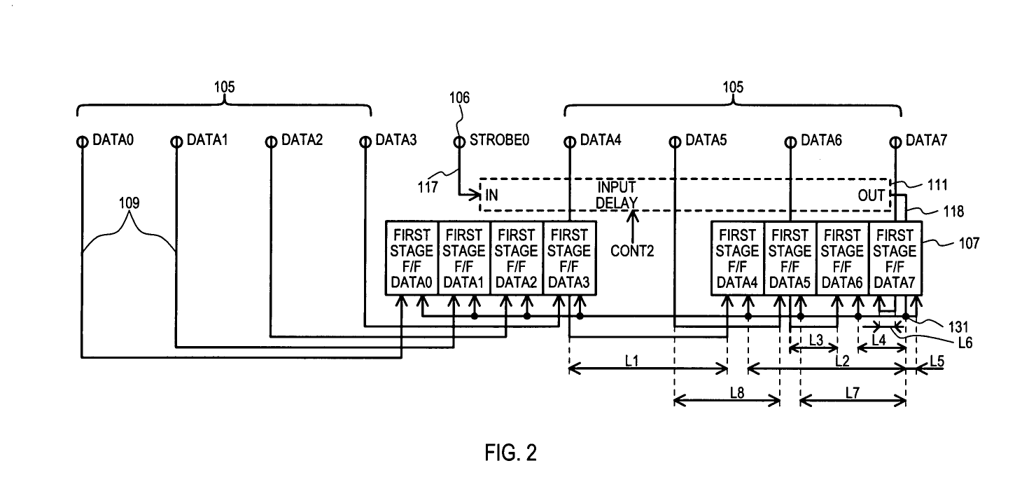

In the very particular memory controller examples shown, data can be input/output in units of 8 bits, as shown in FIGS. 1 and 2. Thus, the m data I/O terminals 105 and n signal I/O terminals 106 can be arranged according to the ratio of one signal I/O terminal 106 for every eight data I/O terminals 105.

Digital data to be captured in the data storing circuit 121 of circuit core 102 can be input from a DDR-SDRAM to data I/O terminals 105. Digital data stored within data storing circuit 121 can be output to a DDR-SDRAM from data I/O terminals 105. Input clock signals, which will be described in more detail at a later point herein, can be input from a DDR-SDRAM to signal I/O terminals 106. In addition, output strobe signals can be output to the DDR-SDRAM from signal I/O terminals 106.

As shown in FIG. 3, “m” first stage FFs 107 and “m” final stage FFs 108 can be arranged in a line between a circuit core 102 and the line of data I/O terminals 105 and signal I/O terminals 106. First stage FFs 107 can operate as input holding circuits, while final stage FFs 108 can operate as output holding circuits.

As shown in FIGS. 1 and 2, “m” data I/O terminals 105 and “m” first stage FFs 107 can be connected to each other through “m” data input wirings 109. Further, “M” data I/O terminals 105 and “m” final stage FFs 108 can be connected to each other through “m” data output wirings 110.

First stage FFs 107 can temporarily hold digital data being input through data I/O terminals 105 for subsequent storage in data storing circuit 121 within circuit core 102. Final stage FFs 108 can temporarily store digital data provided by data storing circuit 121 of circuit core 102 can be output through data I/O terminals 105.

As shown in FIG. 1, “m” final stage FFs 108 are arranged in positions that are physically adjacent to “m” data I/O terminals 105. Data I/O terminals 105 can be connected to final stage FFs 108 through data output wirings 110. Data output wirings 110 can be straight.

As shown in FIG. 2, and as will be described in more detail at a later point herein, “m” first stage FFs 107 may not be arranged in positions that are physically adjacent to “m” data I/O terminals 105. However, the “m” first stage FFs 107 can be connected to one another through data input wirings 109 which can be formed to have particular predetermined shapes.

In a memory controller 100 like that shown in the embodiment of FIG. 1, each of “n/2” output delay circuits 112 can be arranged for every two of “n” signal I/O terminals 106. Further, each output delay circuit 112 can be physically adjacent to a corresponding signal I/O terminal 106. Also, as shown in FIG. 3, “n” input delay circuits 111 and “n/2” output delay circuits 112, including a DLL, and the like, can be arranged between the linear aligned data/signal I/O terminals (105/106) and linear aligned first stage and final stage FFs (107/108).

Input delay circuit 111 can delay the input clock signal received by signal I/O terminal 106 by a predetermined amount of time to generate an input strobe signal. The input strobe signal can be transmitted to first stage FFs 107. The predetermined amount of delay may be a quarter clock cycle, as but one example. Output delay circuit 112 can delay an output clock transmitted from clock generating circuit 122 of circuit core 102 to generate an output strobe signal for output on signal I/O terminals 106. The predetermined amount of delay may be a quarter clock cycle, as but one example.

Referring to FIG. 3, a delay adjusting circuit 123 of circuit core 102 can be connected to input delay circuits 111 and output delay circuits 112. A delay amount can be set in accordance with control signals CONT1 and CONT2 provided by delay adjusting circuit 123.

As shown in FIG. 1, in a memory controller 100 according to one embodiment, each of n/2 output delay circuits 112 can be connected to every two of n signal I/O terminals 106 through n signal output wirings 115. Each of signal output wirings 115 can be formed to be essentially equal in length to each data output wiring 110.

In addition, as shown in FIG. 2, n signal I/O terminals 106 and n input delay circuits 111 can be connected to one another through n signal input wirings 117. Further, the n input delay circuits 111 can be connected to every eight of the m first stage FFs 107 through signal input wirings 118.

Still further, in the embodiment of FIG. 2, each first stage FF 107 can be centrally positioned with respect to the output of input delay circuit 111 and the corresponding data I/O terminal 105. That is, the signal input wirings 117 and 118, and data input wirings 109 are formed, so that with respect to each particular first stage FF 107, a length of data wiring 109 can be equal to the corresponding length of input wirings 117 and 118.

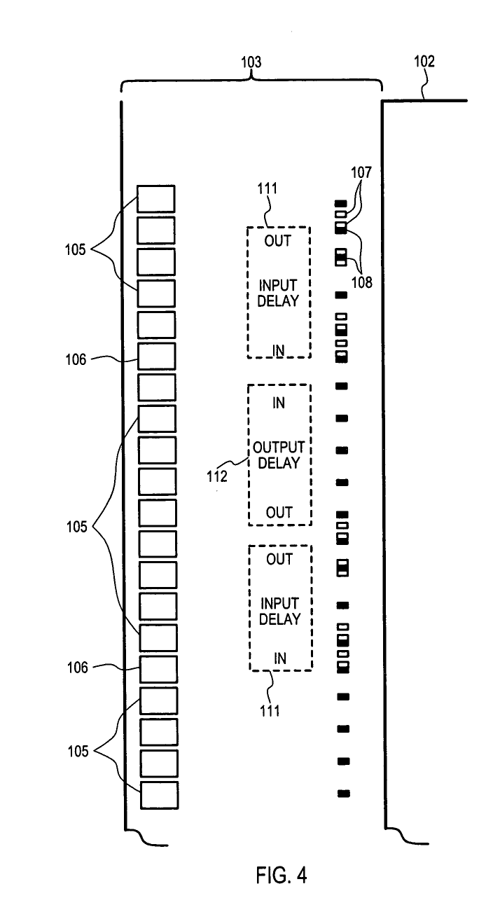

It is noted that in FIG. 2, for ease in understanding, first stage FFs 107 are shown in blocks, with each block composed of four first stage FFs 107. However, a preferred implementation is represented in FIG. 4.

Referring to FIG. 4, first stage FFs 107 can be individually arranged in middle positions between the output (OUT) of an input delay circuit 111 and a corresponding data I/O terminal 105.

In addition, referring to FIG. 2, in a memory controller 100 of a preferred embodiment, a wiring length of a signal input wiring 118 from input delay circuit 111 to a predetermined position 131 can be made equal to a longitudinal wiring length of data input wiring 109. At same time, as noted previously, for every first stage FF 107, a transverse wiring length of signal input wiring 118 and a transverse wiring of data input wiring 109 can be made essentially equal to one another, as follows: L₁=L₂, L₃=L₄, . . .

Because positions of data I/O terminals and signal I/O terminals can be fixed according to chip type, a description will now be given of an arrangement of delay circuits and FFs which can be changed in position according to the design needs thereof.

First, a description will be given with respect to the arrangement of output delay circuits 112 and final stage FFs 108 used in outputting data. As represented by FIG. 1, each of output delay circuits 112 can be arranged so that the position of its output terminal can be located, in a longitudinal direction in FIG. 1, at a middle position between adjacent signal I/O terminals 106. In addition, final stage FFs 108 can be arranged so as to be equidistant with respect to corresponding data I/O terminals 105. Still further, a wiring length from a final stage FF 108 to the corresponding data I/O terminal 105, and a wiring length from the output of output delay circuit 112 and each signal I/O terminal can be made essentially equal to one another.

It is noted that a difference in the longitudinal distance between the output of output delay circuit 112 and different signal I/O terminals 106 can exist, provided a resulting signal skew falls within the range of a designed value. However, for the purposes of ensuring a highest degree of freedom in design, it is desirable that such longitudinal differences be essentially equal to one another.

In such an arrangement, because the phase of clock signals supplied to output delay circuits 112 and final stage FFs 108 can be controlled to be essentially equal to one another using clock tree synthesis (CTS), thus skew can be substantially removed. Consequently, only a delay time for output delay circuit 112 can be adjusted, to thereby generate a strobe signal that is out of phase with data signals (synchronized according to a clock signal). In one particular approach, output delay circuit 112 can be adjusted in accordance with a control signal CONT1. Such an adjustment can correspond to a quarter clock cycle with a high degree of accuracy.

Next, a description will be given with respect to the arrangement of FFs for inputting data. As shown in FIG. 2, the position of an input terminal of input delay circuit 111 can be aligned with the position of signal I/O terminal 106, and thereby determine the position of input delay circuit 111. After determining the position of input delay circuit 111, first stage FFs 107 can be arranged in positions so that a distance between the output of the input delay circuit 111 (which can be a delay locked loop DLL) and corresponding data I/O terminals 105 can be essentially equal to one another. This arrangement can result in a transverse (horizontal direction in FIG. 2) wiring length from data I/O terminals 105 to corresponding first stage FFs 107 being nearly equal to a wiring length from signal I/O terminal 106 to first stage FFs 107.

Further, a longitudinal wire length from the output terminal of input delay circuit 111 to a first stage FF 107 can be essentially the same as a longitudinal (vertical in FIG. 2) direction wiring length from data I/O terminals 105 to first stage FFs 107.

With such essentially same wiring lengths, introduction of clock skew can be essentially removed. Consequently, a highly accurate out-of-phase clock signal containing essentially no skew can be generated from a strobe signal received by input delay circuit 111.

It is noted that a delay amount introduced by a delay input circuit 111 can be controlled to be a quarter cycle of a clock signal, for example, in accordance with a control signal CONT2. In addition, if reference is made to FIG. 3, because first stage FFs 107 can be arranged parallel with data I/O terminals 105, such first stage FFs 107 may not be shifted in a transverse direction (horizontal in FIG. 3), but instead can be adjusted in the longitudinal direction (vertical in FIG. 3) to arrive at adjusted wiring lengths. By thus eliminating design constraints in the transverse direction, designing a resulting device can be made easier.

The operation of an embodiment of the present invention will now be described.

With the configuration described above, a memory controller 100 according to an embodiment can receive digital data with an input clock signal from a DDR-SDRAM, and store such data in data storing circuit 121 of circuit core 102. Also, digital data within data storing circuit 121 of circuit core 102 can be output together with an output strobe signal to a DDR-SDRAM.

More specifically, in the case where a memory controller 100 according to one embodiment fetches digital data from a DDR-SDRAM, such digital data can be input in parallel to m data I/O terminals 105. At the same time, input clock signals, synchronous with such digital data, can be input in parallel to n signal I/O terminals 106.

Digital data input to m data I/O terminals 105 can be individually transmitted to m first stage FFs 107 through m data input wirings 109. Also, input clock signals input to n signal I/O terminals 106 can be individually transmitted to n input delay circuits 111 through n signal input wirings 117.

An input delay circuit 111, as represented by FIG. 12, can delay an input clock signal (STROBE0) by a predetermined delay, to generate an input strobe signal (STROBE). Such input strobe signals can be transmitted to m first stage FFs 107 through signal input wirings 118. First stage FFs 107 can temporarily hold input digital data in synchronism with the strobe signal. Such held data can be stored in data storing circuit 121 of circuit core 102.

In addition, with the configuration described above, a memory controller 100 according to an embodiment can output data to a DDR-SDRAM. Clock generating circuit 122 of circuit core 102 can generate an output clock signals. Such output clock signals can be transmitted to final stage FFs 108 and to n output delay circuits 112. It is noted that output clock signals transmitted to final stage FFs 108 and output delay circuits 112 can be skew adjusted using CTS.

Groups of m final stage FFs 108 can temporarily hold output digital data in synchronism with output clock signals, thus such digital data can be output from corresponding groups of m data I/O terminals 105 to a DDR-SDRAM in synchronism with such output clock signals.

At this time, each output delay circuit 112 can delay an output clock signal by a predetermined amount to generate an output strobe signal. Such an output strobe signal can be output from a signal I/O terminal 106. A DDR-SDRAM can then store (e.g., capture) such output digital data synchronously with such an output strobe signal.

The various embodiments can result in advantageous effects.

In a memory controller 100 according to one embodiment, as described above, when data is output to a DDR-SDRAM digital data for output through data I/10 terminals 105 can be temporarily held in final stage FFs 108 synchronously with output clock signals. At the same time, output strobe signals can be transmitted from output delay circuits 112 to signal I/O terminals 106 synchronously with an output clock signal.

Also, in a memory controller 100 according to one embodiment, and as shown in FIG. 1, each of (n/2) output delay circuits 112 can be arranged every two of n signal I/O terminals 106, so as to be adjacent thereto. Also, as shown in FIG. 3, (n/2) output delay circuits 112 can be arranged in a middle region between a linear alignment of data I/O terminals 105 and a linear arrangement of final stage FFs 108.

Referring still to FIG. 1, in an arrangement like that described above, data output wirings 110 through which final stage FFs 108 and data I/O terminals 105 are connected to each other can be essentially equal in length to signal output wirings 115 that connect the output of a delay circuit 112 to each signal I/O terminal 106. Such matching wiring lengths can enable digital data and an output strobe signals to be accurately synchronized with respect to each other.

Moreover, in a memory controller 100 according to one embodiment, each of (n/2) output delay circuits 112 can transmit an output control signal to two of n signal I/O terminals 106. This can reduce the number of output delay circuits 112 by half, as compared to the above-described conventional arrangements.

In addition, in a memory controller 100 according to one embodiment, as described above, when input digital data is acquired, output strobe signals can be transmitted from input delay circuits 111 to first stage FFs 107 synchronously with an input clock signal. Such input digital data, received at data I/O terminals 105 can be temporarily stored in first stage FFs 107 synchronously with the output strobe signal.

Referring to FIG. 2, in an arrangement like that described above, for every first stage 107 a length of an associated one of m data input wirings 109 can be made equal to a total length of an associated one of m signal input wiring 118. Hence, the delay of digital data transmitted from data I/O terminals 105 to first stage FFs 107 can be essentially equal to that of digital data transmitted from signal input terminal 106 to input delay circuit 111 and from the output of input delay circuit 111 to first stage FFs 107. In this way, it can be possible to remove skew between input digital data and a corresponding input strobe signal.

In a memory controller 100 according to one embodiment, digital data output from a DDR-SDRAM and an output strobe signal can be accurately synchronized with one another without having dedicated delay circuits, or the like, as utilized in conventional arrangements. Similarly, digital data output from a DDR-SDRAM and an input strobe signal can be accurately synchronized with one another. Thus, by not having to include dedicated delay circuits for each data input, circuit scale can be reduced providing more chip area. Further, the design and/or manufacture of a memory controller can be made easier. Still further, productivity for designing and manufacturing such a device can be excellent and resources do not have to be committed to determining particular delays for multiple data inputs.

The above-described embodiments could be subject to various modifications.

Thus, the present invention is not intended to be limited to the particular embodiments set forth above, and various changes may be made without departing from the gist of the invention.

As but one example, the above embodiments have described an arrangement having (n/2) output delay circuits 112 connected to n signal I/O terminals 106 by way of n signal output wirings 115. In such an arrangement, circuit scale can be reduced and signal output wirings 115 and lengths of data output wirings 110 can be made essentially equal to one another. This can reduce space consumed on a device.

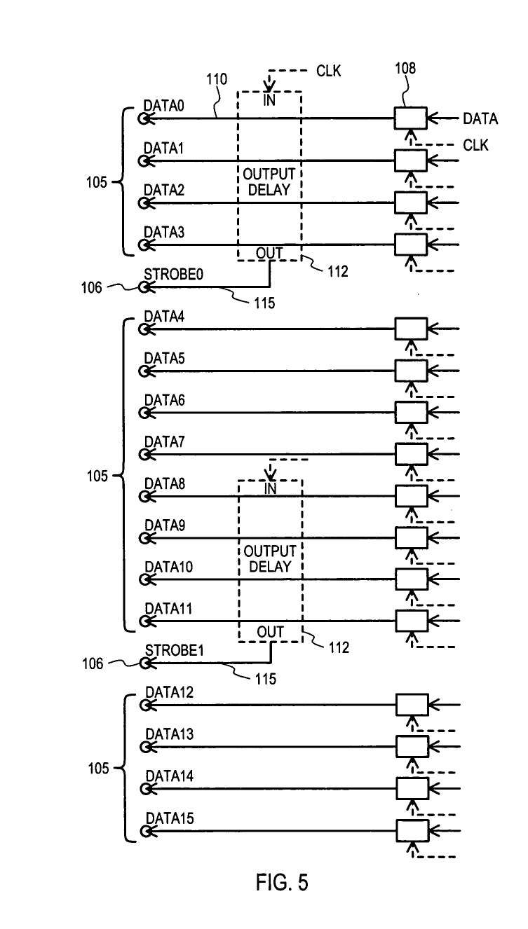

However, as shown in FIG. 5, a memory controller can include n output delay circuits 112 connected to n signal I/O terminals 106 by signal output wirings 115. In this case, output delay circuits 112 and final stage FFs 108 can be arranged in the vicinity of one another so that signal output wirings 115 and data output wirings 110 have substantially identical lengths.

More specifically, output delay circuits 112 can be arranged so that positions of their output terminals are aligned, in a vertical direction, with corresponding signal I/O terminals 106. In addition, final stage FFs 108 can be positioned with respect to corresponding data I/O terminals 105 so as to be equidistant from such data I/O terminals 105. In this arrangement, wiring lengths from final stage FFs 108 to corresponding data I/O terminals 105 can be substantially equal to a wiring length from an output of output delay circuit 112 to a corresponding signal I/O terminal 106.

In the above modification, because an output delay circuit 112 can be provided for each signal I/O terminal, there can be essentially no error due to a longitudinal (vertical direction in FIG. 5) direction of wiring 115. Hence, it can be possible to essentially remove a skew between digital data and an output strobe signal with a high degree of accuracy, without having to take a longitudinal wiring length into consideration.

In addition, because an output delay circuit 112 can be provided for every signal I/O terminal 106, each output strobe signal can be closely controlled. It is noted that in cases where it is desirable to make a wiring length of each signal output wiring 115 and a wiring length of each data output wiring 110 essentially equal, any of signal output wirings 115 or data output wirings 110 can be drawn around to allow such wirings to be equal to one another. Such an approach can require additional calculations over other embodiments.

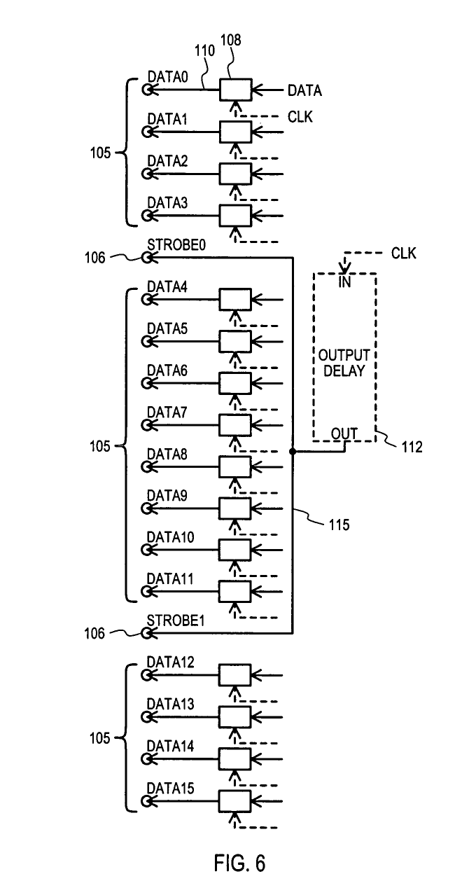

Moreover, in the above-mentioned embodiment, input delay circuits 111 and output delay circuits 112 are described as being arranged in a line within a middle region between the linear arrangement of signal I/O terminals 106 and the linear arrangement of final stage FFs 108. However, the order of such aligned circuit elements can be changed. As but one example, as shown in FIG. 6, output delay circuits 112 and/or input delay circuits 111 (not shown in FIG. 6) can be linear aligned to one side of both data I/Os 105 and final stage FFs 108.

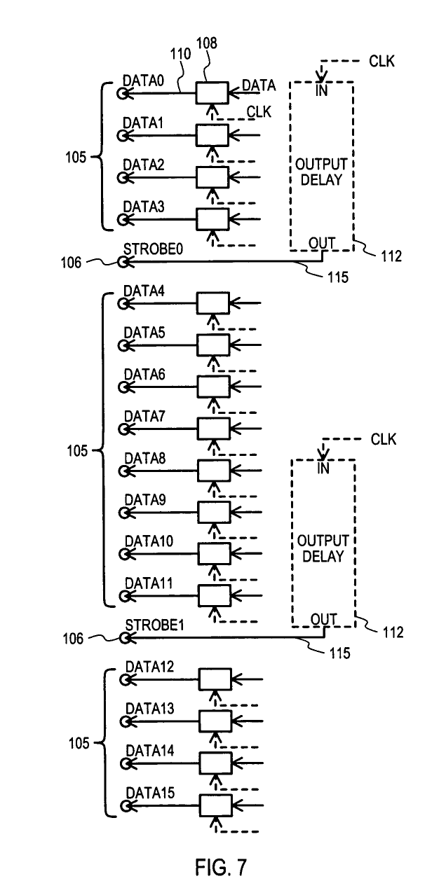

Of course, as shown in FIG. 7, other configurations can include n output delay circuits 112 connected to n signal I/O terminals 106 through n signal output wirings 115. Like circuit elements can be arranged in the following order: signal I/O terminals 106, final stage FFs 108, and output delay circuits 112 (and/or input delay circuits 111, not shown).

It is further noted that in actual implementation a circuit size of each final stage FF 108 can be smaller than each of output delay circuits 112. Accordingly, in the case where such output delay circuits 112, signal I/O terminals 106, final stage FFs 108, and output delay circuits 112 (and/or input delay circuits 111) are linear aligned as set forth in FIG. 7, the output of delay circuits 112 can be made in close proximity with signal I/O terminals 106. In this case, signal output wirings 105 and data output wirings 110 can be substantially equal to one another. Thus, a phase shift between digital data to be output and an output strobe signal can be made to fall within a desired tolerance range.

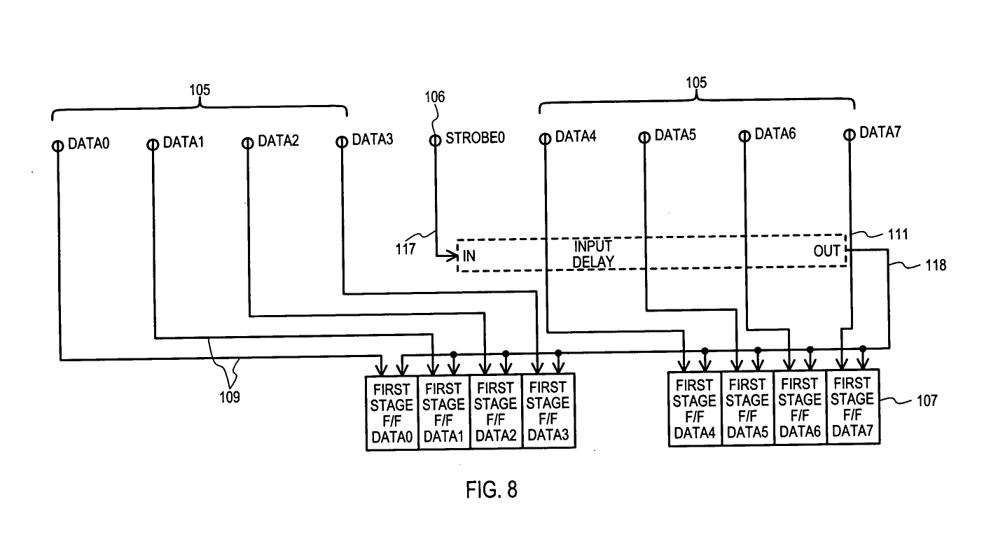

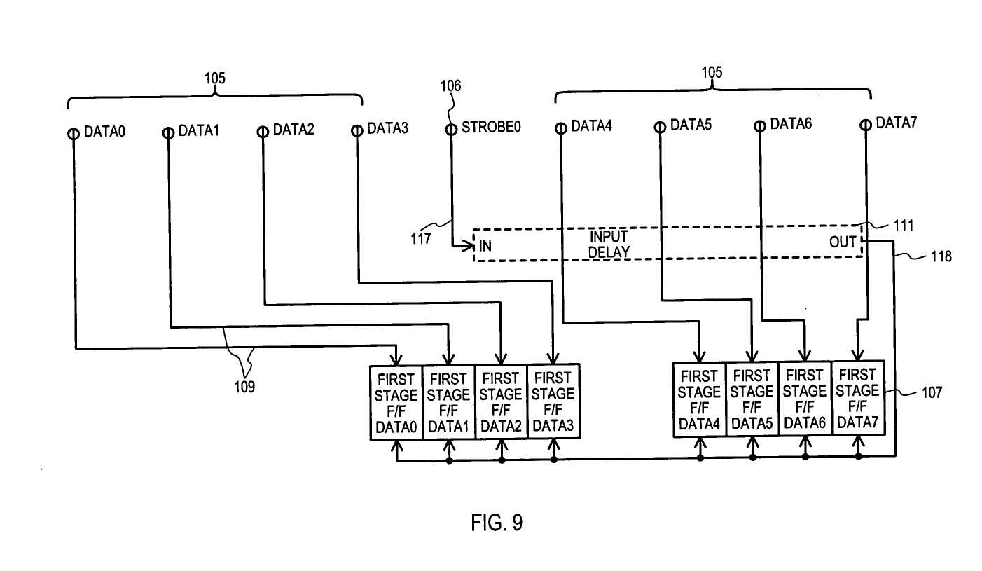

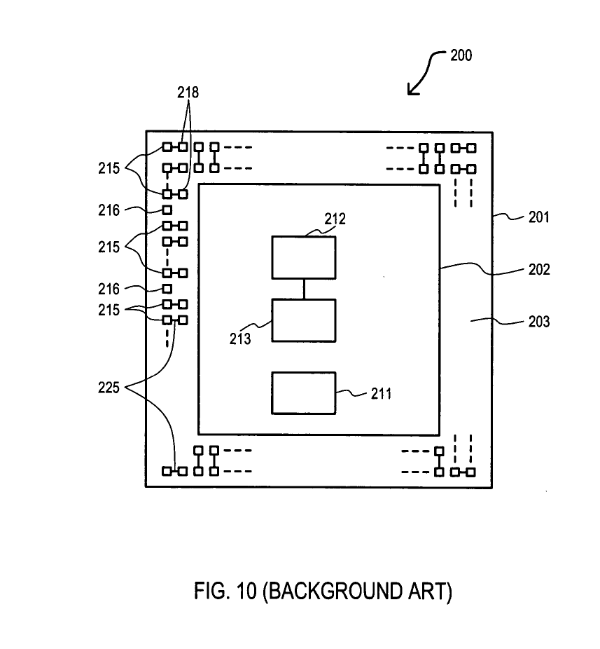

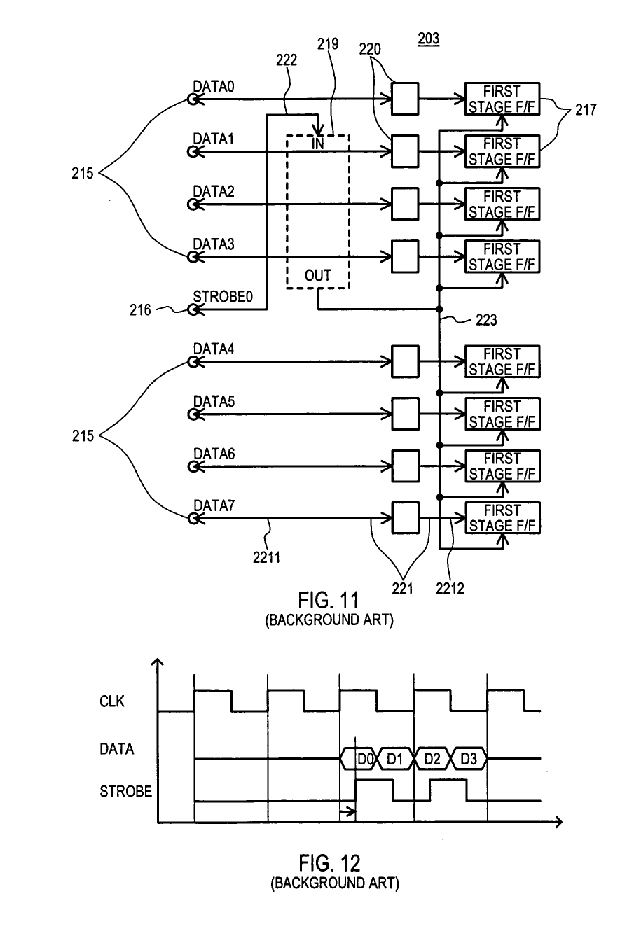

In addition, in the above-described embodiments (e.g., FIG. 2), data I/O terminals 105 and first stage FFs 107 have been shown connected to each other through data input wirings 109, each of which is drawn with a “U” like shape. Also, input delay circuits 111 and first stage FFs 107 are shown connected to one another with signal input wirings 118 drawn with a U-like shape. However, as shown in FIG. 8, input data wirings 109 and/or signal input wirings 118 can have a “crank” like shape. Still further, as shown in FIG. 9, one of input data wirings 109 (or signal input wirings 118) can have a crank-like shape, while the other of signal input wirings 118 (or input data wirings 109) can have a U-like shape.

However, as described above, in the case where the direction of data input wirings 109 and signal input wirings 118 to a given first stage FFs 107 are made the same as each other, a design process can be simplified, as wiring lengths are managed only with respect to one direction (e.g., transverse). However, in case where directions between a data input wiring 109 and a signal input wiring 118 are different from one another, one of such wirings may have to drawn around to increase its length to thereby arrive at lengths that are essentially equal to one another.

The present invention may have various advantageous effects.

In a memory controller according to one embodiment, m output holding circuits can be provided for every m output data terminals, so as to be arranged adjacent thereto. Further, n output delay circuits for every n signal output terminals, so as to be arranged adjacent thereto. A wiring length from output holding circuits to data output terminals, and a wiring length from output delay circuits to signal output terminals can be essentially equal to one another. A delay for digital data transmitted from output holding circuits to data output terminals can be essentially equal to a delay of output strobe signals transmitted from output delay circuits to signal output terminals. Hence, digital data and output strobe signals can be accurately synchronized with one another.

In a memory controller according to another embodiment, m output holding circuits can be provided for every m data output terminals, so as to be arranged adjacent thereto. Further, (n/a) output delay circuits can be provided for every “a” signal output terminals of n such signal output terminals. Each output delay circuit can thus be adjacent to a corresponding “a” signal output terminals. Wiring lengths from output holding circuits to corresponding data output terminals can be essentially equal to a wiring length from the output of each output delay circuit to the corresponding signal output terminals. A delay for digital data transmitted from output holding circuits to data output terminals can be essentially equal to a delay of output strobe signals transmitted from output delay circuits to corresponding “a” signal output terminals. Hence, digital data and output strobe signals can be accurately synchronized with one another.

In a memory controller according to yet another embodiment, m output holding circuits can be provided for every m data output terminals, so as to be arranged adjacent thereto. Further, (n/2) output delay circuits can be provided for every two signal output terminals of n such signal output terminals. Each output delay circuit can thus be adjacent to a corresponding two signal output terminals. Wiring lengths from output holding circuits to corresponding data output terminals can be essentially equal to a wiring length from the output of each output delay circuit to the corresponding two signal output terminals. A delay for digital data transmitted from output holding circuits to data output terminals can be essentially equal to a delay of output strobe signals transmitted from output delay circuits to corresponding two signal output terminals. Hence, digital data and output strobe signals can be accurately synchronized with one another.

In a memory controller according to yet another embodiment, m data input wirings and m signal input wirings are formed to corresponding input holding circuits. The length of corresponding data input wirings and signal input wirings can be made essentially equal to one another. Hence, delays of digital data transmitted from data input terminals to data holding circuit can be essentially the same as the delay of an input strobe signal transmitted from an input delay circuit to the same data holding circuit. Thus, digital data and an input strobe signal can be accurately synchronized with one another.

It is noted that while the various embodiments set forth herein have been described in detail, the present invention could be subject to various changes, substitutions, and alterations without departing from the spirit and scope of the invention. Accordingly, the present invention is intended to be limited only as defined by the appended claims.

What is claimed is:

1. A memory controller connected to a semiconductor memory device, comprising:
a clock generating circuit that generates an output clock signal;
a data generating circuit that provides output digital data;
a predetermined number “m” data output terminals that provide output data to the semiconductor memory device in parallel;
m output holding circuits for storing the output digital data synchronously with the output clock signal;
a predetermined number “n” signal output terminals that provide output strobe signals to the semiconductor memory device in synchronism with the output data, where n<m; and
a plurality of output delay circuits including one output delay circuit for every “p” signal output terminal(s), where p is an integer greater than zero, each output delay circuit delaying the output clock signal by a predetermined amount to transmit an output strobe signal to the corresponding p signal output terminal(s); wherein
each m output holding circuit is physically adjacent to a corresponding one of the m data output terminals; and
the output of each output delay circuit is adjacent to the corresponding p signal output terminal(s).

2. The memory controller of claim 1, wherein:
the m output data output terminals and n signal output terminals are linearly aligned with one another;
the m holding circuits are linearly aligned with one another; and
the plurality of output delay circuits are linearly aligned with one another between m holding circuits and the aligned m data output terminals and n signal output terminals.

3. The memory controller of claim 1, wherein:
the value p is greater than one, and the value n is a multiple of p.

4. The memory controller of claim 1, wherein:
value of p is selected from the group consisting of one and two.

5. The memory controller of claim 1, wherein:
the value of p is one.

6. The memory controller of claim 1, wherein:
the value of p is two; and
each of the plurality of output delay circuits has an output terminal arranged equidistant from the corresponding two signal output terminals.

7. The memory controller of claim 1, further including:
a plurality of data input terminals that receive input data from the semiconductor memory device;
a signal input terminal for every “q” data input terminals, where “q” is an integer greater than 2, each signal input terminal receiving an device input clock signal from the semiconductor memory device in synchronism with the input data;
an input delay circuit corresponding to each signal input terminal that delays a received device input clock form the semiconductor memory device signal by a predetermined amount to generate an input strobe signal, the input delay circuits being arranged between the signal input terminals and positions where the input delay circuits output the input strobe signals; and
an input holding circuit corresponding to each data input terminal, each group of q input holding circuits holding input data in synchronism with the input strobe signal from a corresponding input delay circuit; wherein
the input data is transmitted to the data generating circuit through the data input terminals.

8. The memory controller of claim 1, further including:
a plurality of data input terminals that receive input data from the semiconductor memory device;
a signal input terminal for every “q” data input terminals, where “q” is an integer greater than 2, each signal input terminal receiving a device input clock signal from the semiconductor memory device in synchronism with the input data;
an input delay circuit corresponding to each signal input terminal that delays a received device input clock signal from the semiconductor memory device by a predetermined amount to generate an input strobe signal, the input delay circuits being arranged between the signal input terminals and positions where the input delay circuits output the input strobe signals; and
an input holding circuit corresponding to each data input terminal, each group of q input holding circuits holding input data in synchronism with the input strobe signal from a corresponding input delay circuit;
a first wiring corresponding to each data input terminal that transmits digital data to a corresponding input holding circuit; and
a second wiring corresponding to each input holding circuit that transmits the input strobe signal from a corresponding input delay circuit to the input holding circuit; wherein
the first and second wiring corresponding to each input holding circuit being essentially equal in length.

9. The memory controller of claim 1, wherein:
the m data output terminals are also data input terminals that receive input data from the semiconductor memory device in parallel; and
the n signal output terminals are also signal input terminals for receiving device input clock signals from the semiconductor memory device in synchronism with the input data.

10. The memory controller of claim 1, wherein:
the output holding circuits transmit output digital data synchronously with both a rising edge and a falling edge of the output clock signal.

11. The memory controller of claim 1, further including:
a plurality of data input terminals that receive input data from the semiconductor memory device;
a signal input terminal for every “q” data input terminals, where “q” is an integer greater than 2, each signal input terminal receiving an device input clock signal from the semiconductor memory device in synchronism with the input data; and
an input delay circuit corresponding to each signal input terminal that delays a received device input clock form the semiconductor memory device signal by a predetermined amount to generate an input strobe signal, the input delay circuits being arranged between the signal input terminals and positions where the input delay circuits output the input strobe signals;
an input holding circuit corresponding to each data input terminal, each group of q input holding circuits holding input data in synchronism with the input strobe signal from a corresponding input delay circuit; wherein
the input holding circuits transmit input data to the data generating circuit synchronously with both a rising edge and a falling edge of the corresponding input strobe signal.

12. The memory controller of claim 1, further including:
the semiconductor memory device being coupled to the memory controller by the m data output terminals and the n signal output terminals.

13. The memory controller of claim 1, further including:
a circuit core region in which the clock generating circuit and data generating circuit are formed; and
an interface region surrounding the circuit core region in which the data output terminals, output holding circuits, signal output terminals, and output delay circuits are formed; wherein
each output holding circuit comprising a first latch circuit.

14. The memory controller of claim 13, further including:
the data output terminals are data input/output (I/O) terminals;
the signal output terminals are signal I/O terminals;
m input holding circuits corresponding to the data I/O terminals formed in the interface region, each input holding circuit comprising a second latch circuit connected to a corresponding data I/O terminal by a first wiring, the input holding circuits holding input data in synchronism with a corresponding input strobe signal; and
an input delay circuit connected to each signal I/O terminal by a second wiring, each input delay circuit delaying a received device input clock from the semiconductor memory device signal by a predetermined amount to generate an input strobe signal, each input strobe signal being connected to a corresponding second latch circuit by a third wiring; wherein
the length of the first wiring to each second latch circuit is essentially equal to the sum of the lengths of the second and third wirings corresponding to the same second latch circuit.

15. A memory controller connected to a semiconductor memory device, comprising:
a predetermined number “m” data input terminals that receive input data from the semiconductor memory device;
a predetermined number “n” signal input terminals, each signal input terminal receiving a device input clock signal from the semiconductor memory device in synchronism with the input data, where m>n;
a data storing circuit for receiving digital data from the data input terminals;
n input delay circuits that delay received device input clock signals from the semiconductor memory device by a predetermined amount to generate input strobe signals;
m input holding circuits that hold the input data in synchronism with the input strobe signals generated by the input delay circuits; and
m data input wirings, each data input wiring transmitting an input data value from one data input terminal to a corresponding input holding circuit; and
m signal input wirings transmitting one input strobe signal from one input delay circuit to a corresponding input holding circuit; wherein
the data input wiring and signal input wiring for the same corresponding input holding circuit being essentially equal in length.

16. The memory controller of claim 15, wherein:
the input delay circuits are arranged between the signal input terminals and locations where the input delay circuits output the input strobe signals.

17. The memory controller of claim 15, wherein:
the input holding circuits transmit input data to the data generating circuit synchronously with both a rising edge and a falling edge of the corresponding input strobe signal.

18. The memory controller of claim 15, further including:
the semiconductor memory device being coupled to the memory controller by the m data input terminals and the n signal input terminals.

19. The memory controller of claim 15, further including:
a circuit core region in which the data storing circuit are formed; and
an interface region surrounding the circuit core region in which the data input terminals, input holding circuits, signal input terminals, input delay circuits, signal input wirings, and data input wirings are formed; wherein
each input holding circuit comprising a first latch circuit.

20. The memory controller of claim 15, further including:
the m data input terminals and n signal input terminals are linearly aligned with one another; and
the m input holding circuits are linearly aligned with one another parallel to the data input terminals and signal input terminals.

21. The memory controller of claim 15, further including:
a clock generating circuit that generates an output clock signal;
a data generating circuit that provides output digital data;
a plurality of data output terminals that that provide output data to the semiconductor memory device in parallel;
a signal output terminal for every “q” data output terminals, where “q” is an integer greater than 2, each signal output terminal providing an output strobe signal to the semiconductor memory device in synchronism with the output data;
an output delay circuit for every “p” signal output terminal(s), where p is an integer greater than zero, each output delay circuit delaying the output clock signal by a predetermined amount to transmit an output strobe signal to the corresponding p signal output terminal(s); and
an output holding circuit corresponding to each data output terminal, each group of q output holding circuits holding output data in synchronism with the output strobe signal from the corresponding output delay circuit.
